(19) United States
(12) Patent Application Publication
(10) Pub. No.: US 2008/0167964 A1
(43) Pub. Date: Jul. 10, 2008

(54) Method and System for Implementing a Customer Incentive Program

(75) Inventors: Thomas E. Chefalas, Somers, NY (US); Steven J. Mastrianni, Unionville, CT (US); Ajay Mohindra, Yorktown Heights, NY (US); Clifford A. Pickover, Yorktown Heights, NY (US)

Correspondence Address: FREDERICK W. GIBB, III;Gibb & Rahman, LLC, 2568-A RIVA ROAD, SUITE 304, ANNAPOLIS, MD, 21401, US

(73) Assignee: Inernational Business Machines Corporation, Armonk, NY (US)

(21) Appl. No.: 12/054,513

(22) Filed: Mar. 25, 2008

Related U.S. Application Data
(63) Continuation of application No. 11/029,150, filed on Jan. 4, 2005.

(51) Int. Cl. G06Q 30/00

(52) U.S. Cl. 705/14

(57) ABSTRACT

A system and method for implementing a customer incentive program that conditionally rewards a customer based upon the customer's movement through a shopping area and/or responses to questions which refer to the shopping area, sections of the shopping area and/or products located in the shopping area. While moving through a shopping area, a customer is monitored using a customer tracking system and/or presented with questions using a customer interface device. The customer is rewarded based upon the nature of the customer's movements and/or the nature of the customer's responses. The customer incentive program is designed to expose a customer to particular sections of a shopping area or specified products in the shopping area in order to motivate customer impulse buying.

### CROSS-REFERENCE TO RELATED APPLICATIONS

This application is a Continuation of U.S. application Ser. No. 11/029,150 filed Jan. 4, 2005, the complete disclosure of which, in its entirety, is herein incorporated by reference.

### BACKGROUND FOR THE INVENTION

1. Field of Invention

The present invention relates to a marketing method and system and, in particular, to a system and method for implementing a customer incentive program that rewards a customer of a shopping area based upon the customer's movement within the shopping area and/or the customer's responses to questions referring to the shopping area, sections of the shopping area and/or products within the shopping area.

2. Description of the Related Art

Coaxing potential customers to actually look at a product or to be generally aware of a product can be difficult. Manufacturers often resort to using eye-catching packaging and advertising, which can be costly and is often not effective. In addition manufacturers will often pay premiums to have their products positioned in prime locations (e.g., the end of aisle, eye-level shelf on an aisle, near the check-out counter, etc.) within a shopping area. In many different types of stores (e.g., book stores, grocery stores, discount stores, shopping warehouses, etc.) shelves are packed with products and prime product locations can be difficult to obtain. As stores become larger and larger and as store shelves become more and more crowded with different products, it can be difficult for manufacturers to get their particular products seen. It can also be difficult for customers to distinguish one product from another or to distinguish how one product is better than another. Manufacturers often spend large amounts of money on advertising to raise their products above the “noise level” of all the advertising for competing products. Motivating a customer to visit different sections of a shopping area may result in the customer making an impulse purchase of products found in those sections. Similarly, motivating a customer to actually look for a specific product, to pick the product up and to read the information on the product packaging may result in the customer making an impulse purchase of that specific product. In order to increase product visibility and thereby stimulate impulse buying, it would be advantageous to provide a method and system for implementing a customer incentive program that rewards a customer of a shopping area based upon the customer's movement within the shopping area and/or the customer's responses to questions referring to the shopping area, sections of the shopping area and/or products within the shopping area.

### SUMMARY OF THE INVENTION

The present invention comprises a system and method for implementing a customer incentive program that rewards a customer of a shopping area based upon the customer's movement within the shopping area and/or the customer's responses to questions referring to the shopping area, sections of the shopping area and/or products within the shopping area. The customer incentive program is designed to draw a customer's attention to particular sections of a shopping area or to specific products in the shopping area and to thereby motivate customer impulse buying. Customer rewards can be cash, coupons, discounts, rebates, public acknowledgments, services, goods, stocks, gift certificates, bonds, etc.

The system of the present invention provides for monitoring a customer as the customer moves within different sections of a shopping area and/or for eliciting responses from the customer by asking the customer questions as the customer moves through the different sections of the shopping area. The system rewards the customer as a function of the nature of the customer's movement and/or the nature of the responses.

More particularly, the system comprises customer identification devices adapted to identify a customer in the shopping area. The system also comprises a customer tracking system and/or customer interface devices. The customer tracking system monitors the customer's movement through shopping area. The customer tracking system can be any number of different types of tracking systems including: cameras, wireless receivers and corresponding transmitters, radio frequency identification tags and monitors, scanning devices and scan patterns, customer input devices, bio-metric devices, eye-tracking devices and/or any other tracking system that can be used to track a customer's movement through the shopping area. The customer interface devices are positioned in the shopping area and are adapted to elicit customer responses by asking the customer questions and receiving responses from the customer. The elicited responses can refer to the shopping area itself, to different sections within the shopping area, to products located in the shopping area, to customer demographics, etc.

The system of the present invention also comprises a reward processing unit that receives data from the customer tracking system and/or the customer interface devices and is programmed to reward the customer based upon the nature of the customer's movement within the shopping area and/or the nature of the customer's responses. Specifically, the reward processing unit can be programmed to reward the customer based upon data gathered by the customer tracking system, including but not limited to, the date and time the customer enters the shopping area, the length of time the customer spent in the shopping area, the distance traveled in the shopping area, the different shopping sections visited by the customer, the total number of shopping sections visited by the customer, the length of time spent in each shopping section visited, the path taken by the customer through the shopping area, the number of people accompanying the customer through the shopping area, the physiological responses the customer had to selected products in the shopping area and the length of time the customer spent considering selected products in the shopping area. The reward processing unit can also be programmed to reward the customer based upon responses received by the customer interface devices, including but not limited to, the total number of responses received, the number of responses received regarding different sections of the shopping area, the number of responses received regarding different products in the shopping area, the content of responses received and the number of sections in the shopping area where the responses were elicited. Lastly, the system of the present invention can comprise portable units which can be transported by the customer throughout the shopping area and which can contain the customer tracking system (or a part thereof), the reward processing unit, the customer interface device and the customer identification device.

The method of the present invention provides for monitoring a customer as the customer moves within the different sections of a shopping area and/or for eliciting responses from the customer as the customer moves through the different sections of the shopping area. The method further provides for rewarding the customer based upon the nature of the customer's movement through the shopping area and/or based upon the nature of the elicited responses. A customer is identified in a shopping area and monitored as the customer moves through the shopping area. Customer monitoring includes gathering information regarding the customer's movements through the shopping area and by determining the nature of the customer's movement through the shopping area. Additionally, the customer can be asked questions to elicit responses regarding the shopping area, sections of the shopping area, products located in the shopping area, customer demographics, etc., and the nature of those responses can be determined. The customer can then be rewarded as a function of the nature of the movement through the shopping area and/or the nature of the elicited responses. Specifically, the customer can be rewarded based upon a number of criteria related to the customer's movement through the shopping area, including but not limited to, the date and time the customer entered the shopping area, the length of time the customer spent in the shopping area, the distance traveled in the shopping area, the different shopping sections visited by the customer, the total number of shopping sections visited by the customer, the length of time spent in each shopping section visited, the path taken by the customer through the shopping area, the difficulty of the path, the number of people accompanying the customer through the shopping area, the physiological responses the customer had to selected products in the shopping area and the length of time the customer spent considering selected products in the shopping area. The customer can also be rewarded based upon a number of criteria related to the elicited responses, including but not limited to, the total number of responses received, the number of responses received regarding different sections of the shopping area, the number of responses received regarding different products in the shopping area, the content of responses received and the number of sections in the shopping area where responses were elicited. As a part of the method, customers may be permitted to transfer rewards between themselves. Lastly, the method provides for identifying a plurality of shopping areas and establishing a trans-shopping areas reward service bureau for controlling and optionally varying the basis upon which customers are rewarded.

### BRIEF DESCRIPTION OF THE DRAWINGS

The invention will be better understood from the following detailed description with reference to the drawings, in which:

FIG. 1 is a schematic block diagram illustrating a first embodiment of the system of the present invention;

FIG. 2 is a schematic block diagram illustrating second embodiment of the system of the present invention;

FIG. 3 is a schematic block diagram illustrating third embodiment of the system of the present invention;

FIG. 4 is a schematic flow diagram illustrating a first method of the present invention;

FIG. 5 is a schematic flow diagram illustrating second method of the present invention;

FIG. 6 is a schematic flow diagram illustrating third method of the present invention;

FIG. 7 is a schematic flow diagram illustrating the processes 404 of FIGS. 5 and 606 of FIG. 6;

FIG. 8 is a schematic flow diagram illustrating the processes 504 of FIGS. 5 and 608 of FIG. 6;

FIG. 9 is a schematic flow diagram illustrating the processes 408 of FIG. 4, 508 of FIGS. 5 and 612 of FIG. 6; and

FIG. 10 is a schematic block diagram of a data record showing reward functions for different users as the reward function changes through time.

### DETAILED DESCRIPTION OF THE PREFERRED EMBODIMENT OF THE PRESENT INVENTION

The present invention comprises a system and method for implementing a customer incentive program that rewards a customer of a shopping area based upon the customer's movement within the shopping area and/or the customer's responses to questions referring to the shopping area, sections of the shopping area and/or products within the shopping area. The customer incentive program is designed to expose a customer to particular sections of a shopping area, to particular classes of products in a shopping area or to specific products in a shopping area and to thereby motivate customer impulse buying. Customer rewards can be cash, coupons, discounts, rebates, public acknowledgments, services, goods, stocks, gift certificates, bonds, etc. A customer may be an individual person, a group of persons, an artificial agent acting on the behalf of a person or group of persons, etc.

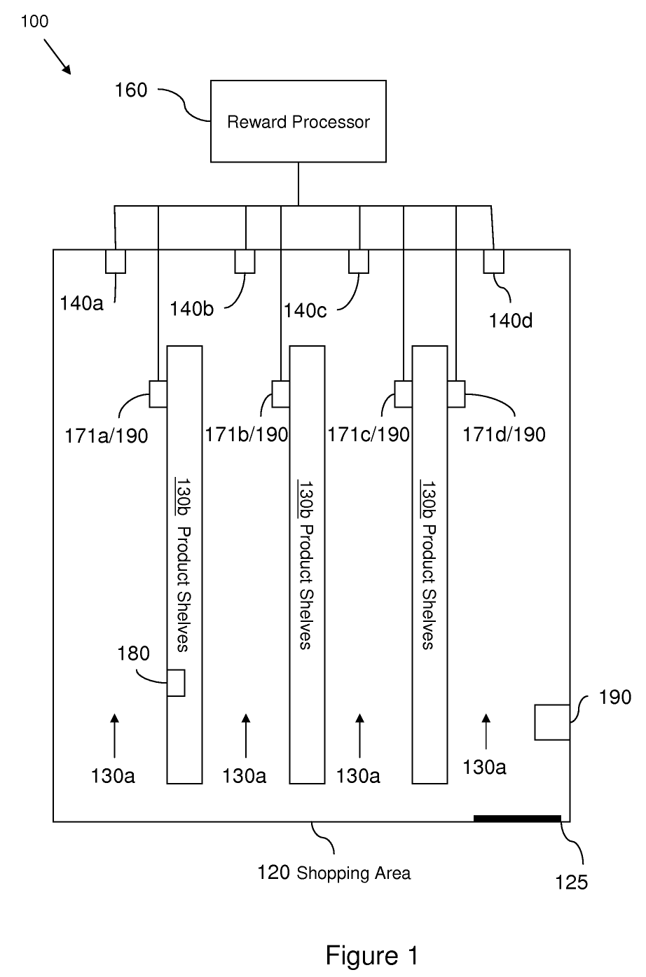

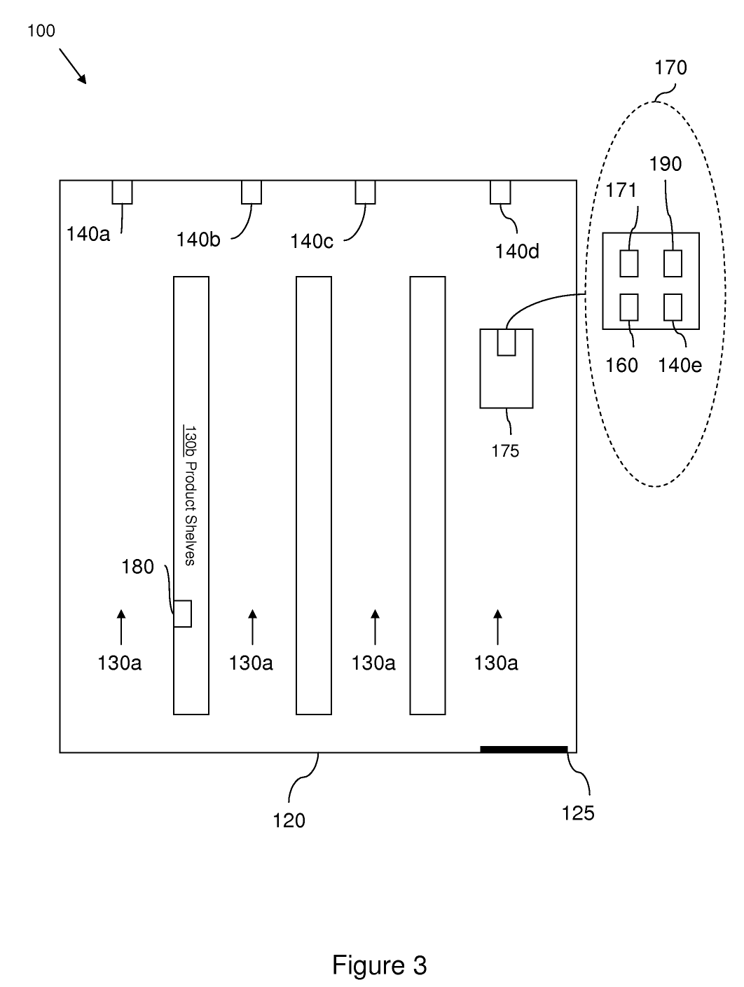

Referring to FIGS. 1 and 3, the shopping area 120 of system 100 can be any area where products or services are purchased such as, an individual store (as illustrated), a set of stores in the same general location (e.g., a mall, shopping plaza, shopping district, etc.), a set of stores that are physically separated (e.g., all stores owned by the same company, etc.), a virtual store(s) (i.e., a store from which products or services can be purchased on-line), a hard copy of a catalogue or an on-line catalogue, an amusement park(s), a trade show(s), an amusement park(s), a convention center(s), a museum(s), a casino(s), a game site(s), a governmental agency(s), etc. The sections 130 of a shopping area 120 can be individual stores within the shopping area 120, different departments within a store (e.g., hardware, clothing, shoes, produce, seafood, etc.), aisles 130a of a store (as illustrated), product shelves 130b (as illustrated) in a store, links on a website, etc.

The system 100 provides for monitoring a customer as the customer moves about the different sections 130 of a shopping area 120 and for eliciting responses from the customer by asking the customer questions as the customer moves about the different sections 130 of the shopping area 120. To accomplish this, the system 100 comprises customer identification devices 190 adapted to identify customers in a shopping area 120. More specifically, the customer identifications devices are adapted to identify a customer entering and moving about the shopping area 120 and to identify a customer answering questions. If the shopping area 120 is large or comprises a set of stores, customer identification devices 190 can be located in each section 130 of the shopping area 120 and can be adapted to identify a customer entering and moving about that particular section 130. These customer identification devices 190 may be stationary, contained in portable units 170 (as illustrated in FIG. 3) and/or integral with customer interface devices 171 (as illustrated in FIG. 1, and discussed in more detail below). The portable device 170 can easily be transported by the customer (e.g., hand-held, attached to the customer's body, connected to the customer's shopping cart 175, etc). The customer identification devices 190 can be adapted to identify a customer by using alphanumeric information (e.g., name, identification number, etc.), biometric information (e.g., fingerprint, voiceprint, etc.), information provided on a card (e.g., a card with a magnetic strip, etc.), information provided on a personal digital assistant (PDA), etc.

Again referring to FIGS. 1 and 3, to monitor a customer's movement within a shopping area 120, the system 100 also comprises a customer tracking system 140. The customer tracking system 140 tracks a customer's movement through shopping area 120, including the customer's movement through the different sections of the shopping area (e.g., aisles 130a-d). The customer tracking system 140 can be any number of different types of tracking systems 140 used to locate and track a customer within a shopping area, including: cameras, wireless receivers and corresponding transmitters, radio frequency identification (RFID) tags and monitors, scanning devices and scan patterns, customer input devices, bio-metric devices, eye-tracking devices and/or any other tracking system that can be used to track a customer's movement through a shopping area 120. Depending upon the defined shopping area (e.g., individual store, set of stores that are geographically separated, virtual store, etc.), a customer's movement through the shopping area can include physical movement within the shopping area (e.g., walking, riding, flying, etc.) or electronic browsing (e.g., web browsing, linking to the different sections of the shopping area, etc.). Depending upon the type of tracking system 140 used, in addition to tracking a customer's movement within a shopping area, these tracking systems 140 can be adapted to determine the length of time the customer spent in the shopping area 120, the different shopping sections 130 visited by the customer, the total number of shopping sections 130 visited by the customer, the length of time spent in each shopping section 130 visited, the path taken by the customer through the shopping sections of shopping area, the difficulty of the path taken; the number of people accompanying the customer through the shopping area, the physiological responses the customer had to selected products in the shopping area, the number or types of products placed in the shopping cart, and the length of time the customer spent considering selected products in the shopping area.

Referring to FIG. 3, the tracking system 140 can comprise a combination of stationary 140a-d and/or portable 140e parts. The stationary parts 140a-d can be set up in different sections 130 throughout the shopping area 120 (as illustrated) or near specific products on the product shelves 130b. A portable part 140e can be contained in a portable unit 170 that can be easily transported by the customer (e.g., hand-held, attached to the customer's body, connected to the customer's shopping cart 175, etc). The stationary 140a-d and portable 140e parts of the tracking system 140 can comprise a combination of an RFID tag and monitor, a scan pattern (e.g., bar code) and scanner, or the like, that can track the customer's movement within the shopping area 120. For example, the stationary parts (e.g., 140a-d) of the tracking system 140 can be barcode scanners set up at the end of each aisle 130a and the portable part 140e, contained in portable unit 170, can be a barcode. The portable barcode can be scanned as a customer passes the various stationary barcode scanners. Alternatively, the portable device 170 can be configured with a portable barcode scanner and a customer can scan barcodes located throughout the store (e.g., at the end of each aisle 130a, on particular products 181, etc.). Another tracking system 140 with a combination of portable 140e and stationary 140a-d parts can be a wireless radio device designed to work in conjunction with a short-range radio network. A short-range radio network can be set up with radio signal detectors (e.g., 140a-d) in different sections 130 of the shopping area 120 for detecting radio signals from a wireless device (e.g., 140e) as the wireless device enters each section 130. Thus, the customer incentive program can be designed to provide rewards as incentive for a customer to move to particular locations throughout the shopping area 120 where stationary parts of the tracking system are positioned in order to expose the customer to a particular section 130 of the shopping area or specific products 180 within the shopping area 120.

Alternatively, the customer tracking system 140 may comprise one or more bio-metric devices used to monitor a customer's physiological/behavioral response to products as the customer moves through the shopping area. For example, a product manufacturer may wish to know a customer is “excited” when he sees a certain cereal package. Such responses indicating excitement can be monitored with devices that record blood pressure, pupil dilation, pulse rate, galvanic skin response, brain waves, blood chemistry, etc. The customer may be rewarded according to the physiological/behavioral responses. The customer tracking system 140 may further comprise one or more attentiveness tracking devices to monitor the customer's degree of attentiveness to specific products as the customer moves through the shopping area 120. For example, a product manufacturer may desire customers consider a certain cereal package for more than 5 seconds. Such responses can be monitored with devices such as cameras or eye-tracking devices. The customer may be rewarded according to the degree of attentiveness.

Referring to FIGS. 1 and 3, to elicit customer responses referring to the shopping area 120, sections 130 of the shopping area 120 and/or specific products 180 within the shopping area 120, customer interface devices 171 can be positioned within the shopping area 120. The customer interface devices 171 can contain an integral customer identification device 190 for identifying the customer answering questions. The customer interface devices 171 can be stationary and positioned throughout the shopping area 120 (e.g., at the end of each aisle 130, as illustrated in FIG. 1). The customer interface devices 171 can also be contained in a portable device 170, as illustrated in FIG. 3. The portable device 170 can easily be transported by the customer (e.g., hand-held, attached to the customer's body, connected to the customer's shopping cart 175, etc). The customer interface devices 171 are adapted to elicit customer responses from identified customers. Specifically, they are adapted to ask questions to identified customers and to receive responses to those questions. The elicited responses can refer to the shopping area 120 itself, to different sections (e.g., aisles 130a-d, product shelves 180a-c, etc.) within the shopping area 120, to products 180 located in the shopping area, and to customer demographics. For example, the customer interface device 171 may be adapted to present the customer with a small test designed to get a customer to pay attention to attributes of a specific product 180 located on a shelf 130b. The test might require the customer to read the product 180 label or note the characteristics of the product 180 packaging. Alternatively, the customer interface device 171 may further be adapted to conduct a survey designed to gather information about the demographics of other customers located near the customer. The customer interface device 171 can be a smart device adapted to remember what questions the customer has previously answered or what products a customer has previously purchased to avoid asking the same questions unnecessarily.

The system 100 also comprises a reward processing unit 160 that is in communication with the customer tracking system 140 and/or customer interface devices 171. The reward processing unit 160 receives and stores data from the customer tracking system 140 and/or the customer interface devices 171 and is programmed to reward the customer based upon the nature of the customer's movement through the shopping area and/or on the nature of the customer's elicited responses. The reward processing unit 160 can exist on a central processing unit adapted to process the rewards for all customers. Alternatively, the reward processing unit 160 may be contained in a portable device 170 (See FIG. 3) and adapted to process the rewards for individual customers. The portable device 170 can easily be transported by the customer (e.g., hand-held, attached to the customer's body, connected to the customer's shopping cart 175, etc).

The reward processing unit 160 can be adapted to determine the nature of the customer's movement within a shopping area 120 and/or the nature of the customer's responses and to reward the customer accordingly. More specifically, data gathered by the tracking system 140 can be used by the reward processing unite 160 to determine the nature of the customer's movement through the shopping area, including but not limited to, the number of times the customer has entered the shopping area, the length of time the customer spent in the shopping area 120, the different shopping sections (e.g., 130a-d, 180a-c, etc.) visited by the customer, the total number of shopping sections (e.g., 130a-d, 180a-c, etc.) visited by the customer, the length of time spent in each shopping section visited, the path taken by the customer through the shopping area (e.g., the order of the aisles 130a-d that walked down), the difficulty of the path taken, the number of products 180 placed in the shopping cart 175, the specific products 180 placed in the shopping cart 175, the number of people accompanying the customer through the shopping area 120, the physiological responses the customer had to selected products 180 in the shopping area 120 and the length of time the customer spent considering selected products 180 in the shopping area 120. Data gathered by the customer interface devices 171 can be used by the reward processing unit 160 to determine the nature of the responses received by the customer interface devices 171, including but not limited to, the total number of responses received, the number of responses received regarding different sections (e.g., 130a-d, 180a-c, etc.) of the shopping area, the number of responses received regarding different products 180 in the shopping area, the content of responses received and the number of sections (e.g., 130a-d, 180a-c, etc.) in the shopping area 120 where the responses were elicited. The reward processing unit 160 can further be programmed with reward rules (i.e., conditions) that make rewards conditional upon given aspects of the nature of the customer's movement in the shopping area and/or the nature of elicited responses. For example, the reward processing unit 160 can be programmed with reward rules that make a specific reward conditional upon the customer following a particular path through the shopping area, the number of times the customer has entered the shopping area, the number of sections the customer has visited, the length of time spent in the shopping area, the date or time the customer enters the shopping area (e.g., a holiday or a non-holiday), customer demographics, number of specific products a customer considers, answers to questions about specific products, etc. The reward rules provide incentive for a customer to move within the shopping area in a particular manner or to respond to questions regarding particular sections of the shopping area or products within the shopping area. An exemplary reward rule may be: “If a customer moves through all aisles in a store, responds to questions referring to three specific products, spends 20 minutes or more in the store in the afternoon, then reward the customer with a $5 discount coupon.”

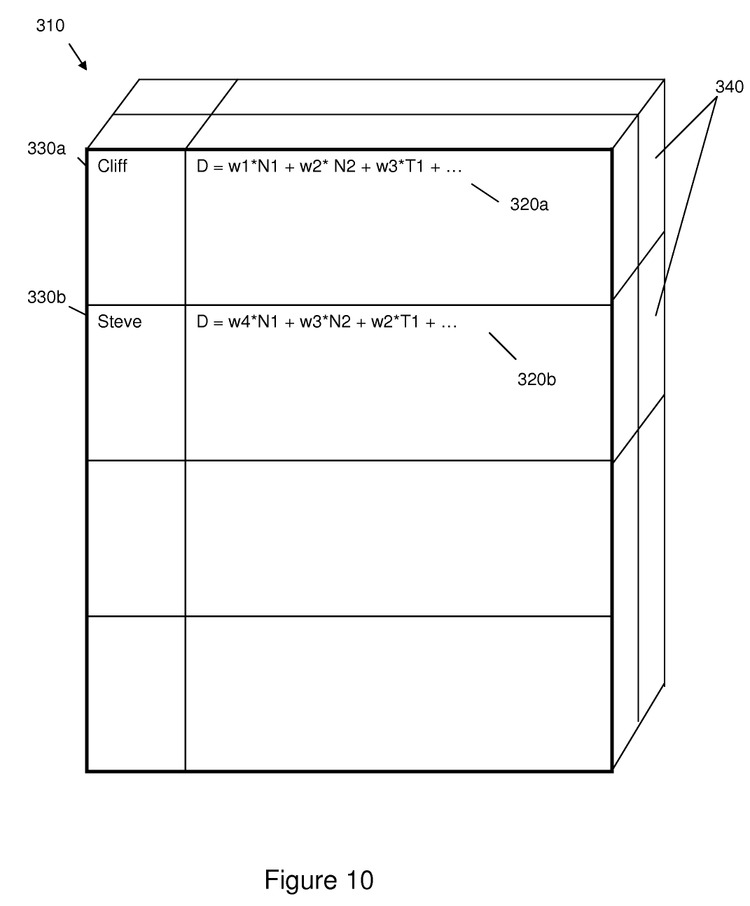

More particularly, a set of rules stored in the reward processing unit 160 may be used to control the reward. The precise reward rule may be in the form of a formula, such as D=N1+N2+T1+T2, where D is the discount, N1 is the number of aisles through which the customer moves, N2 is the number of products considered, T1 is the time spent in the store, and T2 is the time of day. The reward rule formula can also be more complicated, such as D=w1*N1+w2*N2+w3*T1+w4*T2+w5*L+w6*O+w7*Na+w8*S+w9*Di, where D is the reward, N1 is the number of aisles through which the customer moves, N2 is the number of products considered, T1 is the time spent in store, T2 is the time of day, L is the distance the customer traveled, O is a function of the order of sections visited, Na is the nature of the locations visited (i.e., type of section such as produce, dairy, etc.), S is the average length of time spent in each section, and Di is the difficulty of the path traveled. Various weights w may be used to scale the value of each variable (N1, N2, T1, T2, L, O, Na, S, Di, etc.). FIG. 10 illustrates a schematic block diagram of a data record 310 stored in a reward processing unit 160 where the data is input into exemplary reward rules (i.e., functions) 320 for identified customers 330. Different reward rules 320a and 320b may be used for different identified customers 330a and b, respectively. The reward rules may also change over time as indicated by a third dimension 340 for the reward rules record 310. As discussed above, the rewards can be cash, coupons, discounts, rebates, public acknowledgments, services, goods, stocks, gift certificates, bonds, etc. and can be conditional upon the customer moving through particular sections of the store, moving to and/or answering questions about a specific product in the store, spending a certain amount of time in the store, etc. Thus, the amount and nature of the rewards can serve as incentive for the customer to engage in the conditional behavior. Accordingly, the conditions can be designed to increase a customer's exposure to certain sections of the shopping area or to specific products in order to encourage impulse buying.

Referring to FIG. 3, the system 100 can comprise portable units 170 which can be transported by the customer throughout the shopping area 120. These portable units 170 can be handheld units or units attached to shopping baskets, shopping carts, or the like, and they can contain the customer tracking system 140 or a portion thereof, a reward processing unit 160, a customer interface device 171 and/or a customer identification device 190.

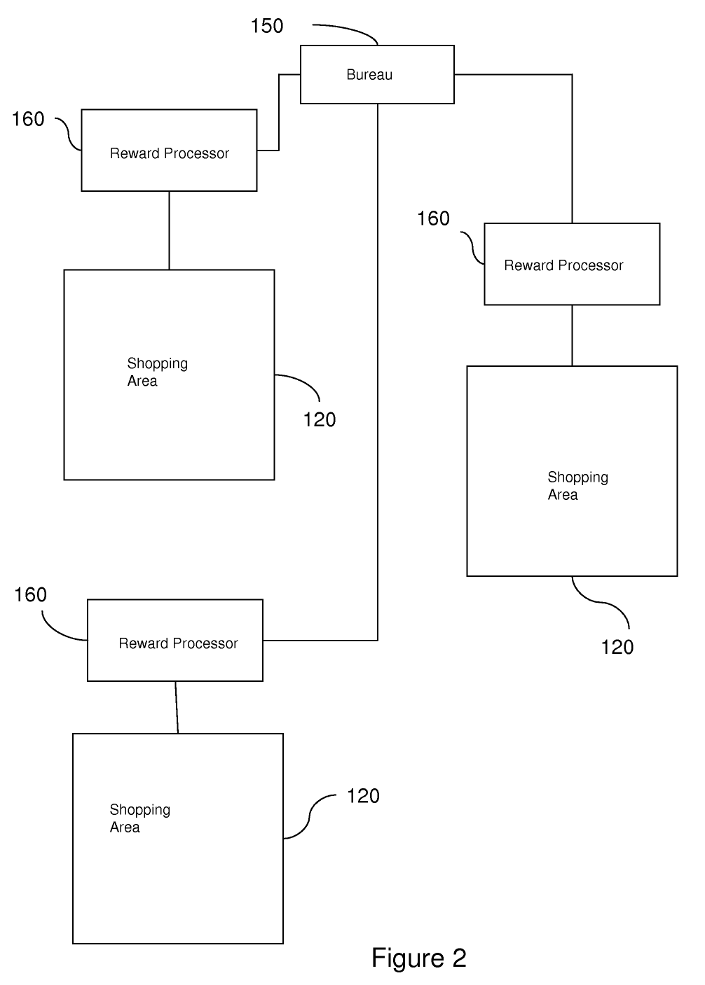

Referring to FIG. 2, a trans-shopping areas rewards service bureau 150 can be established and in communication with the reward processing units from a plurality of shopping areas. The trans-shopping area rewards service bureau 150 may be used to maintain the customer incentive program for multiple shopping areas by setting customer incentive program policies, determining the reward rules for all of the multiple shopping areas and for updating the reward rules from time to time.

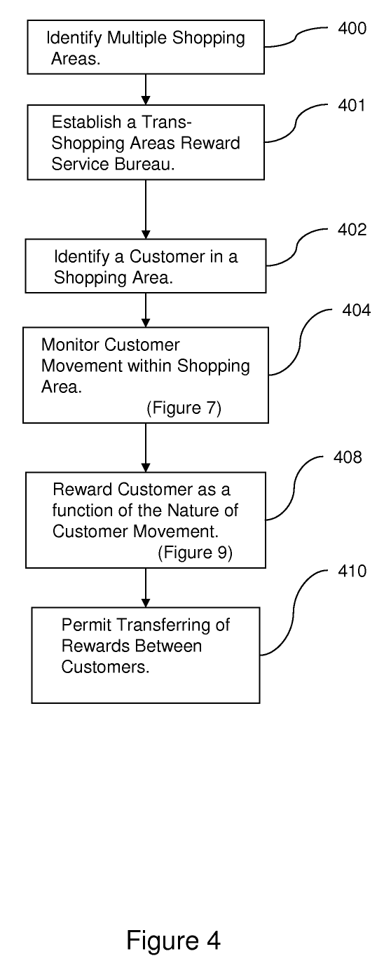

Referring to FIGS. 4-10 in combination, the method of the present invention provides for monitoring a customer moving within a shopping area and/or for eliciting responses from the customer as the customer moves within the shopping area. The method further provides for rewarding the customer based upon the nature of the customer's movement through the shopping area and/or based upon the nature of the elicited responses.

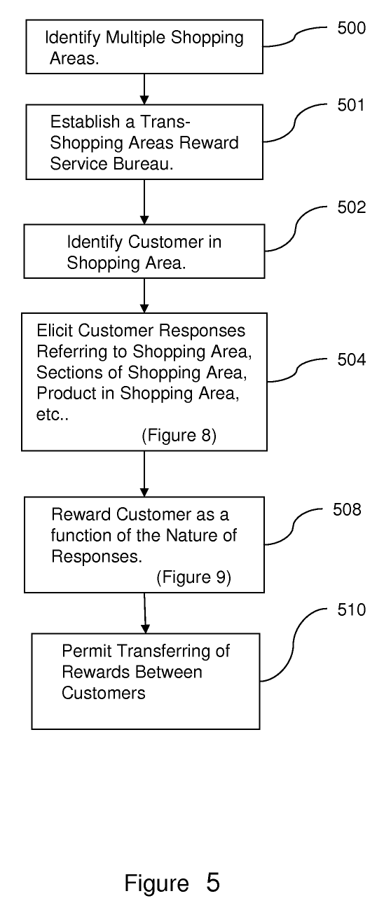

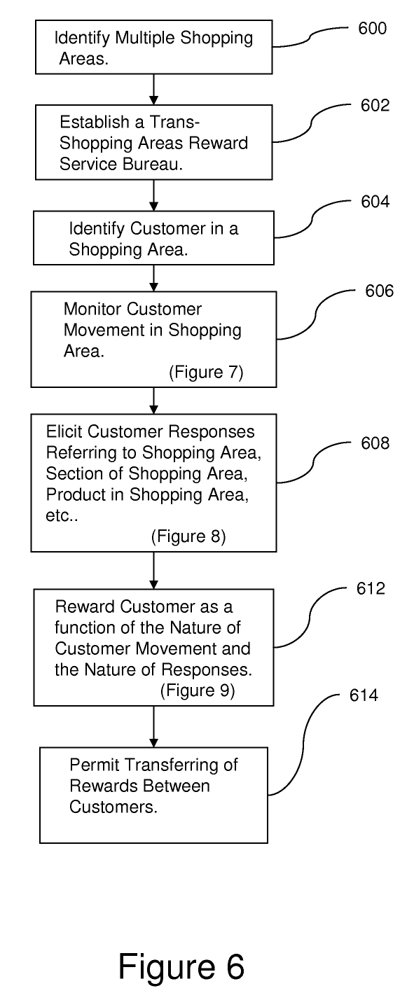

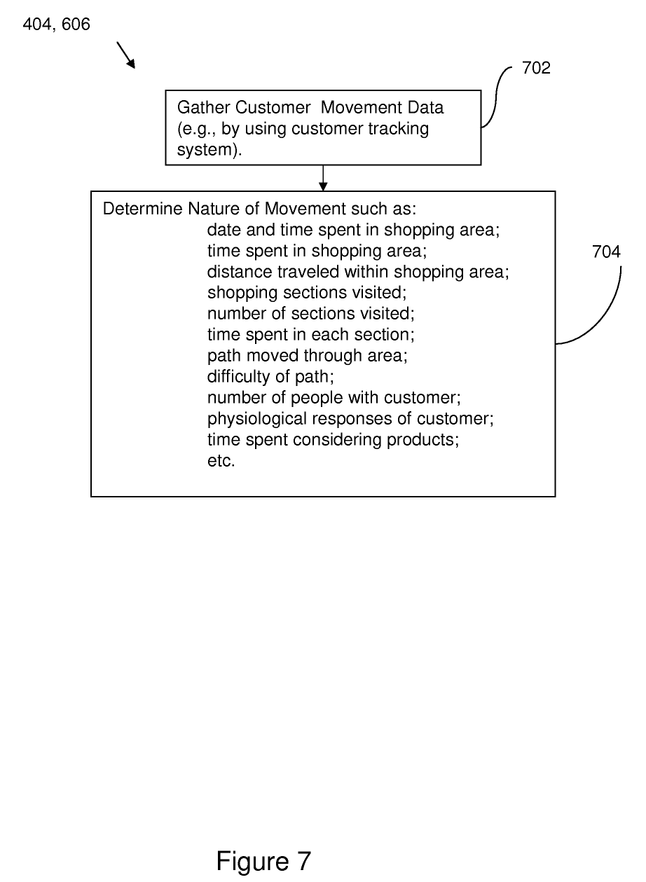

In the alternate embodiments of the method, as illustrated in FIGS. 4-6, a customer is identified in a shopping area (See FIG. 4, Ref. No. 402; FIG. 5, Ref. No. 502; and, FIG. 6, Ref. No. 604). The method can comprise monitoring a customer, e.g., by using a customer tracking system, as the customer moves through the shopping area (See FIG. 4, Ref. No. 404; FIG. 6, Ref. No. 606). Referring to FIG. 7, customer monitoring includes gathering information regarding the customer's movements within the shopping area 702 and determining the nature of the customer's movement within the shopping area 704. The nature of the customer's movement within the shopping area can include, the date and time the customer entered the shopping area, length of time spent in said shopping area, distance traveled within said shopping area, shopping sections visited, total number of said shopping sections visited, length of time spent in each of said shopping sections visited, path taken through said sections of said shopping area, difficulty of said path, number of people accompanying said customer through said shopping area, physiological responses to selected products in said shopping area, length of time spent considering selected products in said shopping area, etc.

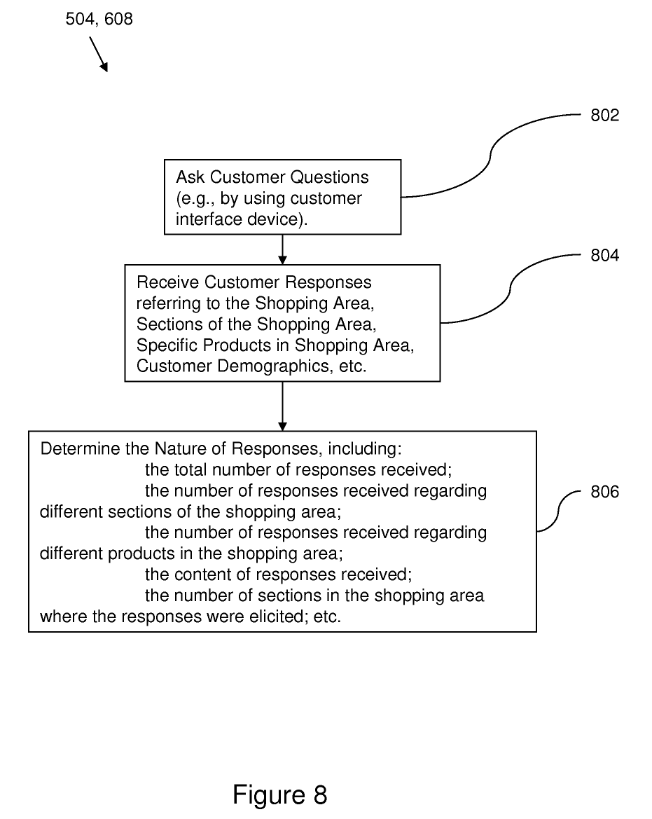

Additionally, the method can comprise eliciting responses from the customer, e.g., by using customer interface devices, (See FIG. 5, Ref. No. 504; FIG. 6, Ref. No. 608). Specifically, referring to FIG. 8, this process 504, 608 is accomplished by asking a customer questions 802. Responses are received and the responses refer to the shopping area, sections of the shopping area, products located in the shopping area, customer demographics, etc., 804. Once responses are received, the nature of those responses can be determined 806. The nature of the responses can include the total number of responses received, the number of responses received regarding different sections of the shopping area, the number of responses received regarding different products in the shopping area, the content of the responses received, the number of sections in the shopping area where the responses were elicited, etc.

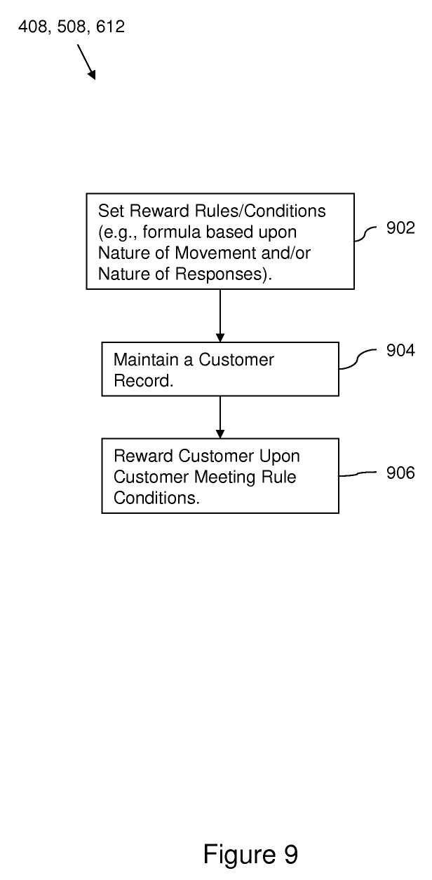

In each embodiment, the customer is rewarded as a function of the nature of the customer's movement, the nature of the responses or both (See FIG. 5, Ref. No. 408, FIG. 5, Ref. No. 508, and FIG. 6, Ref. No. 612, respectively). Referring to FIG. 9, the process of rewarding a customer (408, 508, 612) is described in greater detail. A set of reward rules (i.e., conditions) can be established, maintained, and periodically updated 902 (e.g., in a reward processing unit). The reward rules provide incentive for a customer to move within the shopping area in a certain manner and/or to respond to questions regarding the shopping area, particular sections of the shopping area, or products within the shopping area. The reward rules can be in the form of a formula and can reward the customer conditionally based upon any number of the above listed features of the nature of the customer's movement through the shopping area determined during process 704 of FIG. 7 or the above listed features of the nature of the elicited responses determined during process 806 of FIG. 8. For each identified customer a data record (i.e., customer record) of the nature of the movement and/or the nature of the responses is maintained 904 (e.g., in the reward processing unit) and this data can be input by the reward processing unit into the reward rule. As stated above, with regard to the system of the present invention, the precise reward rule may be in the form of a formula, such as D=N1+N2+T1+T2, where D is the discount, N1 is the number of aisles through which the customer moves, N2 is the number of products considered, T1 is the time spent in the store, and T2 is the time of day. The rule for the reward formula can also be more complicated, such as D=w1*N1+w2*N2+w3*T1+w4*T2+w5*L+w6*O+w7*Na+w8*S+w9*Di, where D is the reward, N1 is the number of aisles through which the customer moves, N2 is the number of products considered, T1 is the time spent in store, T2 is the time of day, L is the distance the customer traveled, O is a function of the order of sections visited, Na is the nature of the locations visited (i.e., type of section such as produce, dairy, etc.), S is the average length of time spent in each section, and Di is the difficulty of the path traveled. Various weights w may be used to scale the value of each variable (N1, N2, T1, T2, L, O, Na, S, Di, etc.). Once the data record indicates that the customer has met the reward conditions established by the reward rule, the customer is awarded accordingly 906.

FIG. 10 illustrates a schematic block diagram of an exemplary data record 310 maintained for identified customers 330. Different reward rules 320a and 320b may be used for different identified customers 330a and b, respectively. The reward rules may also change over time, according to process 702 of FIG. 7, as indicated by a third dimension 340 for the reward rules record 310. For example, on a customer's second visit to a shopping area the customer may be required to spend a lesser amount of time in the shopping area than during the first visit in order to receive a reward.

As discussed above, the rewards can be cash, coupons, discounts, rebates, public acknowledgments, services, goods, stocks, gift certificates, bonds, etc. and can be conditional upon the customer moving through particular sections of the store, moving to and/or answering questions about a specific product in the store, spending a certain amount of time in the store, etc. Thus, the amount and nature of the rewards can serve as incentive for the customer to engage in the conditional behavior. Accordingly, the conditions can be designed to increase a customer's exposure to certain sections of the shopping area or to specific products in order to encourage impulse buying.

The various method embodiments of the present invention can further include the process of permitting customers to transfer rewards between themselves (See FIG. 4, Ref. No. 410; FIG. 5, Ref. No. 510, and FIG. 6, Ref. No. 614). The method embodiments can also include the processes of identifying a plurality of shopping areas (See FIG. 4, Ref. No. 400; FIG. 5, Ref. No. 500, and FIG. 6, Ref. No. 600) and establishing a trans-shopping areas reward service bureau (See FIG. 4, Ref. No. 401; FIG. 5, Ref. No. 501, and FIG. 6, Ref. No. 602). The reward service bureau can be used for setting customer incentive program policies for multiple shopping areas, and for determining and updating customer reward rules for the multiple shopping areas.

To avoid invasion of privacy issues, participating in the customer incentive program implemented with the method and system of the present invention may be optional, such that only customers wishing to participate would be monitored. Additionally, various other aspects of this invention may be secured for privacy and other purposes, so that customer names and reward functions would not be made publicly available.

As described above with reference to FIGS. 1-10, the present invention comprises a system and method for implementing a customer incentive program that conditionally rewards a customer based upon the customer's movement within a shopping area and/or responses to questions which refer to the shopping area, sections of the shopping area and/or products located in the shopping area. Specifically, as a part of the system and method of the present invention a customer can be monitored and/or presented with questions as the customer moves within a shopping area. The customer is rewarded based upon the nature of the customer's movement within the shopping area and/or the nature of the responses elicited. The customer incentive program is designed to expose a customer to particular sections of a shopping area or to specific products in the shopping area, which might otherwise be overlooked, and to thereby motivate customer impulse buying.

What is claimed is:

1. A system for implementing a customer incentive program that rewards a customer moving within a shopping area, said system comprising:
a customer tracking system adapted to monitor said customer's movement within said shopping area; and
a reward processing unit in communication with said customer tracking system, wherein said reward processing unit is adapted to reward said customer as a function of the nature of said movement.

2. The system of claim 1, further comprising a plurality of customer identification devices adapted to identify said customers in said shopping area.

3. The system of claim 1, wherein said nature of said movement comprises the path said customer traveled within said shopping area.

4. The system of claim 1, wherein said shopping area comprises a plurality of shopping sections and wherein said nature of said movement comprises the length of time spent in each of said plurality of shopping sections.

5. The system of claim 1, wherein said nature of said movement comprises said customer's physiological response to a selected product located in said shopping area.

6. The system of claim 1, wherein said nature of said movement comprises the length of time said customer spent considering a selected product located in said shopping area.

7. The system of claim 1, further comprising a portable device transported by said customer as said customer moves within said shopping area;
wherein said portable device comprises at least one of said customer tracking system, a part of said customer tracking system, said reward processing unit and said customer identification device.

8. The system of claim 1, wherein said reward comprises at least one of money, a coupon, a discount, a rebate, a public acknowledgment, a service, an item of goods, a stock, a gift certificate, and a bond.

9. A system for implementing a customer incentive program that rewards a customer moving within a shopping area, said system comprising:
a plurality of customer interface devices adapted to elicit responses from said customer; and
a reward processing unit in communication with said plurality of customer interface devices;
wherein said reward processing unit is adapted to reward said customer as a function of the nature of said responses.

10. The system of claim 9, wherein said responses refer to at least one of said shopping area and to a product located within said shopping area.

11. The system of claim 9, wherein said nature of said responses comprises a number of said responses.

12. The system of claim 9, wherein said nature of said responses comprises the content of said responses.

13. The system of claim 9, further comprising a plurality of customer identification devices adapted to identify said customer in said shopping area.

14. The system of claim 9, further comprising a portable device transported by said customer as said customer moves within said shopping area; wherein said portable device comprises at least one of said reward processing unit, said customer interface device and said customer identification device.

15. The system of claim 9, wherein said reward comprises at least one of money, a coupon, a discount, a rebate, a public acknowledgment, a service, an item of goods, a stock, a gift certificate, and a bond.

16. A system for implementing a customer incentive program that rewards a customer moving within a shopping area, said system comprising:
a customer tracking system adapted to monitor said customer's movements within said shopping area;
a plurality of customer interface devices adapted to elicit responses from said customer; and
a reward processing unit in communication said customer tracking system and said plurality of customer interface devices, wherein said reward processing unit is adapted to reward said customer as a function of the nature of said customer movement and the nature of said responses.

17. The system of claim 16, further comprising a plurality of customer identification devices adapted to identify said customer in said shopping area.

18. The system of claim 16, further comprising a portable device transported by said customer as said customer moves within said shopping area;
wherein said portable device comprises at least one of said customer tracking system, a part of said customer tracking system, said customer interface device, said reward processing unit and said customer identification device.

19. The system of claim 16, wherein said reward comprises at least one of money, a coupon, a discount, a rebate, a public acknowledgment, a service, an item of goods, a stock, a gift certificate, and a bond.

20. A method for implementing a customer incentive program that rewards a customer moving within a shopping area, said system comprising:
monitoring said customer as said customer moves through said shopping area; and
rewarding said customer as a function of the nature of said movement through said shopping area.

21. The method of claim 20, further comprising establishing a trans-shopping areas reward service bureau, wherein said trans-shopping areas reward service bureau determines reward conditions for multiple shopping areas.

22. The method of claim 19, wherein monitoring said customer as said customer moves through said shopping area comprises:
gathering customer movement data, and
determining the nature of said movement.

23. The method of claim 19, wherein rewarding said customer as a function of the nature of said movement through said shopping area further comprises:
setting reward conditions based upon said movement data;
maintaining a customer record of said movement data; and
rewarding said customer once said movement data in said customer record meets said reward conditions.

24. The method of claim 19, further comprising permitting transferring of rewards between customers.

25. A method for implementing a customer incentive program that rewards a customer moving within a shopping area, said method comprising:
eliciting customer responses, and
rewarding said customer as a function of the nature of said responses.

26. The method of claim 25, wherein said responses refer to at least one of said shopping area and a product located within said shopping area.

27. The method of claim 25, wherein eliciting customer responses comprises:
asking said customer questions referring to at least one of said shopping area and a product within said shopping area;
receiving responses from said customer referring to at least one of said shopping area and a product within said shopping area; and
determining the nature of said responses.

28. The method of claim 25, further comprising establishing a trans-shopping areas reward service bureau, wherein said trans-shopping areas reward service bureau determines reward conditions for multiple shopping areas.

29. The method of claim 25, wherein rewarding said customer as a function of the nature of said responses comprises:
setting reward conditions based upon said customer responses;
maintaining a customer record of said responses; and
rewarding said customer once said responses in said customer record meets said reward conditions.

30. The method of claim 19, further comprising permitting transferring of rewards between customers.

31. A method for implementing a customer incentive program that rewards a customer moving within a shopping area, said system comprising:
monitoring said customer as said customer moves through said shopping area;
eliciting customer responses; and
rewarding said customer as a function of the nature of said responses and as a function of the nature of said movement through said shopping area.

32. The method of claim 31, wherein said responses refer to at least one of said shopping area and a product located within said shopping area.

33. The method of claim 31, wherein monitoring said customer as said customer moves through said shopping area comprises:
gathering customer movement data, and
determining the nature of said movement.

34. The method of claim 31, wherein eliciting customer responses comprises:
asking said customer questions referring to at least one of said shopping area and a product within said shopping area;
receiving responses from said customer referring to at least one of said shopping area and a product within said shopping area; and
determining the nature of said responses.

35. The method of claim 35 further comprising establishing a trans-shopping areas reward service bureau, wherein said trans-shopping areas reward service bureau determines reward conditions for multiple shopping areas.

36. The method of claim 35, wherein rewarding said customer as a function of the nature of said responses and the nature of said movement through said shopping area comprises:
setting reward conditions based upon said customer movement data and said responses;
maintaining a customer record of said customer movement data and said responses; and
rewarding said customer once said movement data and responses in said customer record meets said reward conditions.

37. The method of claim 31, further comprising permitting transferring of rewards between customers.

38. The method of claim 31, wherein said method process of rewarding said customer further comprises providing said customer with at least one: money, a coupon, a discount, a rebate, a public acknowledgment, a service, an item of goods, a stock, a gift certificate, and a bond.
